(19) United States
(12) Patent Application Publication
(10) Pub. No.: US 2018/0231713 A1
(43) Pub. Date: Aug. 16, 2018

(54) POLARIZATION ROTATOR-SPLITTER USING MODE CONVERSION

(71) Applicant: Marie-Josée Picard, Quebec (CA)

(72) Inventor: Marie-Josée Picard, Quebec (CA)

(73) Assignee: Ciena Corporation, Hanover, MD (US)

(21) Appl. No.: 15/435,085

(22) Filed: Feb. 16, 2017

(51) Int. Cl. G02B 6/126; G02B 6/14; G02B 6/122; G02B 6/27

(52) U.S. Cl. CPC G02B 6/126; G02B 6/14; G02B 2006/12097; G02B 6/2726; G02B 6/2773; G02B 6/1228

(57) ABSTRACT

A mode coupler for modal conversion. The mode coupler includes a first rib waveguide configured to propagate, through a coupling region, a first optical signal comprising a second TE mode portion, wherein the second TE mode is associated with a second TE mode refractive index in the first rib waveguide, a second rib waveguide disposed in proximity to the first rib waveguide across the coupling region, where the first TE mode is associated with a first TE mode refractive index in the second rib waveguide that substantially matches the second TE mode refractive index in the first rib waveguide, and the coupling region configured to convert the second TE mode portion of the first optical signal into a second optical signal in the second rib waveguide, where the second optical signal is in the first TE mode of the second rib waveguide.

### BACKGROUND

A waveguide is a physical structure that confines and guides the propagation of an electromagnetic (EM) wave or optical signal. A mode is an electromagnetic (EM) field pattern in a waveguide. A mode is associated with an order that relates to a geometric aspect of the EM field pattern. For example, the fundamental mode (or zero-th order mode) is the lowest order mode followed by the first order mode, second order mode, etc. A polarization diversity scheme is a scheme to separate multiple polarizations, or modes, in the EM wave or optical signal. The polarization diversity scheme may be used in sub-micronic waveguides to control birefringence of the transverse electrical (TE) mode and transverse magnetic (TM) mode.

### SUMMARY

In general, in one aspect, one or more embodiments of the invention relate to a mode coupler for generating a first transverse electric (TE) mode from a second TE mode of signal propagation. The mode coupler includes a first rib waveguide having at least the second TE mode of signal propagation. The first rib waveguide is configured to propagate, at least through a coupling region for modal conversion, a first optical signal including a second TE mode portion in the second TE mode. The second TE mode is associated with a second TE mode refractive index in the first rib waveguide. The mode coupler includes a second rib waveguide having at least the first TE mode of signal propagation. The second rib waveguide is disposed in proximity to the first rib waveguide across the coupling region. The first TE mode is associated with a first TE mode refractive index in the second rib waveguide that substantially matches the second TE mode refractive index in the first rib waveguide. The coupling region is configured to convert the second TE mode portion of the first optical signal into a second optical signal in the second rib waveguide. The second optical signal is in the first TE mode of the second rib waveguide.

In general, in one aspect, one or more embodiments of the invention relate to a polarization rotator splitter for splitting an input optical signal into separate outputs in a first transverse electric (TE) mode of signal propagation. The polarization rotator splitter includes a bi-level taper disposed at an input side of a coupling region. The bi-level taper is configured to convert a transverse magnetic (TM) mode portion of the input optical signal into a second TE mode portion, in a second TE mode, of a first optical signal. The polarization rotator splitter further includes a mode coupler coupled (e.g., abutted) to the bi-level taper. The mode coupler includes a first rib waveguide having the first TE mode and the second TE mode of signal propagation. The first rib waveguide is configured to propagate the first optical signal at least through a coupling region for modal conversion. The second TE mode is associated with a second TE mode refractive index in the first rib waveguide. The mode coupler further includes a second rib waveguide having at least the first TE mode of signal propagation. The second rib waveguide is disposed in proximity to the first rib waveguide across the coupling region. The first TE mode is associated with a first TE mode refractive index in the second rib waveguide that substantially matches the second TE mode refractive index in the first rib waveguide. The coupling region is configured to convert the second TE mode portion of the first optical signal into a second optical signal in the second rib waveguide. The second optical signal is in the first TE mode of the second rib waveguide.

In general, in one aspect, one or more embodiments of the invention relates to a method for modal conversion to generate a first transverse electric (TE) mode from a second TE mode of signal propagation. The method includes obtaining a mode coupler having a first rib waveguide in proximity to a second rib waveguide across a coupling region for the modal conversion. The first rib waveguide supports a second TE mode having a second TE mode refractive index that substantially matches a first TE mode refractive index of the first TE mode in the second rib waveguide. The method further includes applying, to the first rib waveguide at an input side of the coupling region, a first optical signal including a TE mode portion in the second TE mode. The method further includes converting, using the coupling region, the second TE mode portion of the first optical signal into a second optical signal in the second rib waveguide. The second optical signal is in the first TE mode of the second rib waveguide.

Other aspects of the invention will be apparent from the following description and the appended claims.

### BRIEF DESCRIPTION OF DRAWINGS

FIG. 1 shows a diagram of a mode coupler in accordance with one or more embodiments of the invention.

FIG. 2 shows a diagram of a polarization rotator splitter in accordance with one or more embodiments of the invention.

FIGS. 3.1 and 3.2 show a flowchart in accordance with one or more embodiments of the invention.

FIGS. 4.1 and 4.2 show an example in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In the following description, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention provide a mode coupler and a polarization rotator splitter based on the mode coupler. In one or more embodiments of the invention, the mode coupler includes a first rib waveguide and a second rib waveguide that are in proximity to each other across a coupling region. In particular, a second TE mode refractive index of a second TE mode in the first rib waveguide substantially matches a first TE mode refractive index of a first TE mode in the second rib waveguide. The first rib waveguide is configured to propagate, at least through the coupling region for modal conversion, a first optical signal having at least a portion propagating in the first rib waveguide, referred to as the second TE mode portion of the optical signal. Further, the coupling region is configured to convert the second TE mode portion of the first optical signal into a second optical signal in the second rib waveguide, where the second optical signal is in the first TE mode of the second rib waveguide. Throughout this disclosure, the first TE mode and the second TE mode refer to different TE modes without explicitly specifying the order of the TE modes. For example, the first TE mode may be any of the fundamental TE mode, first order TE mode, second order TE mode, etc. Similarly, the second TE mode may be any of the fundamental TE mode, first order TE mode, second order TE mode, etc. In some embodiments of the invention, the first TE mode is a fundamental TE mode (referred to as TE0 mode) and the second TE mode is a first order TE mode (referred to as TE1 mode).

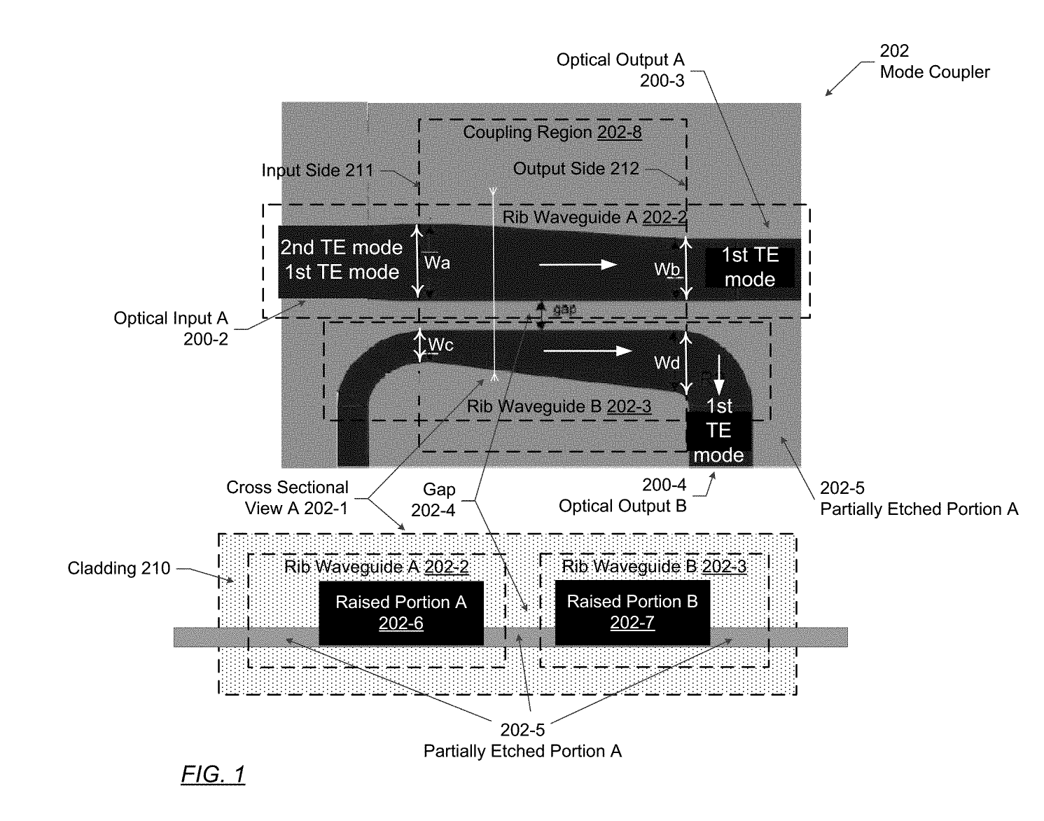

FIG. 1 shows a diagram of a mode coupler (202) in accordance with one or more embodiments of the invention. A mode coupler is a coupler based on a coupling mechanism that uses one or more modes of the waveguides. In one or more embodiments, one or more of the modules and elements shown in FIG. 1 may be omitted, repeated, and/or substituted. Accordingly, embodiments of the invention should not be considered limited to the specific arrangements of modules shown in FIG. 1.

A coupler is two coupled waveguides sufficiently adjacent to each other such that energy passing through one waveguide is coupled to the other waveguide. As shown in FIG. 1, the mode coupler (202) includes a rib waveguide A (202-2) and a rib waveguide B (202-3) that are disposed in proximity to each other at least across the coupling region (202-8) for modal conversion. As used herein, modal conversion is converting the EM wave or optical signal energy in one mode (e.g., at the optical input A (200-2)) into another EM wave or optical signal in a different mode (e.g., at the optical output B (200-4)). A rib waveguide is a waveguide having a rib-shaped cross section with a raised portion superimposing a slab. In one or more embodiments, as shown in the cross sectional view A (202-1), the rib waveguide A (202-2) and rib waveguide B (202-3) include a greater than 220 nano-meter (nm) thick raised portion A (202-6) and a greater than 220 nm thick raised portion B (202-7), respectively, as well as a greater than 90 nm thick partially etched portion A (202-5) (i.e., slab) that is shared by the rib waveguide A (202-2) and rib waveguide B (202-3). In one or more embodiments, the distance between the rib waveguide A (202-2) and rib waveguide B (202-3) widens external to the coupling region (202-8) to specifically define the coupling region (202-8). For example, the rib waveguide B (202-3) bends to enter and exit the coupling region (202-8).

As used herein, “in proximity” means that the adjacent edges of the two waveguides are within a pre-determined range, such as 200 nm. In particular, the rib waveguide A (202-2) and rib waveguide B (202-3) are separated by a gap (202-4) between the two adjacent edges across the coupling region (202-8). In some embodiments, as shown across the coupling region (202-8), the separation distance (i.e., width of the gap (202-4)) between the adjacent edges is substantially constant within a manufacturing tolerance range. In one or more embodiments, the mode coupler (202) is fabricated using a silicon photonics fabrication process and the manufacturing tolerance range is an aggregate of processing step variations of the silicon photonics fabrication process. Although not explicitly shown, in some other embodiments, the separation distance (i.e., width of the gap (202-4)) between the adjacent edges varies across the coupling region (202-8). In one or more embodiments, the width of the gap (202-4) is greater than 200 nm. In other words, the minimum separation distance, whether constant or varying across the coupling region (202-8), is at least 200 nm.

In one or more embodiments, the raised portion A (202-6), raised portion B (202-7), and partially etched portion A (202-5) are enclosed in the cladding (210) to form the rib waveguide A (202-2) and rib waveguide B (202-3). Specifically, the cladding (210) includes a material or a combination of materials (e.g., glass, air, oxide, etc.) having a suitable property (e.g., refractive index) to confine the EM wave or optical signals therein. In particular, relative positions and separate distance of the rib waveguide A (202-2) and rib waveguide B (202-3) are maintained within the cladding (210). In one or more embodiments, during the silicon photonics fabrication process, the rib waveguide A (202-2) and rib waveguide B (202-3) are fabricated from a single silicon layer having a greater than 220 nm thickness where the partially etched portion A (202-5) is selectively etched from the single silicon layer to reduce the thickness for forming the aforementioned rib configuration. In one or more embodiments, the thickness of the raised portion A (202-6) and raised portion B (202-7) is between 300 nm and 400 nm, the thickness of the partially etched portion A (202-5) is between 100 nm and 250 nm and the width of the gap (202-4) is between 200 nm and 400 nm.

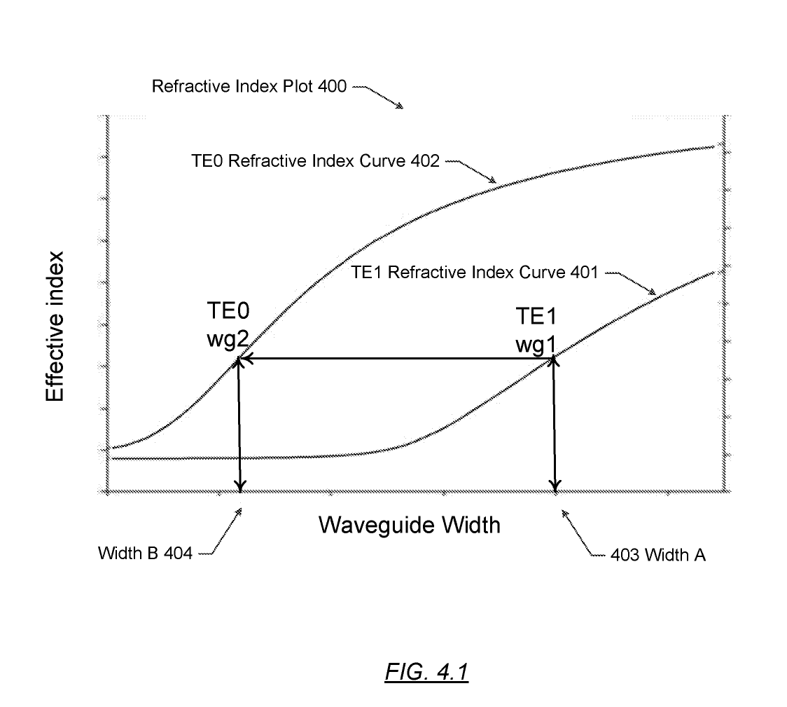

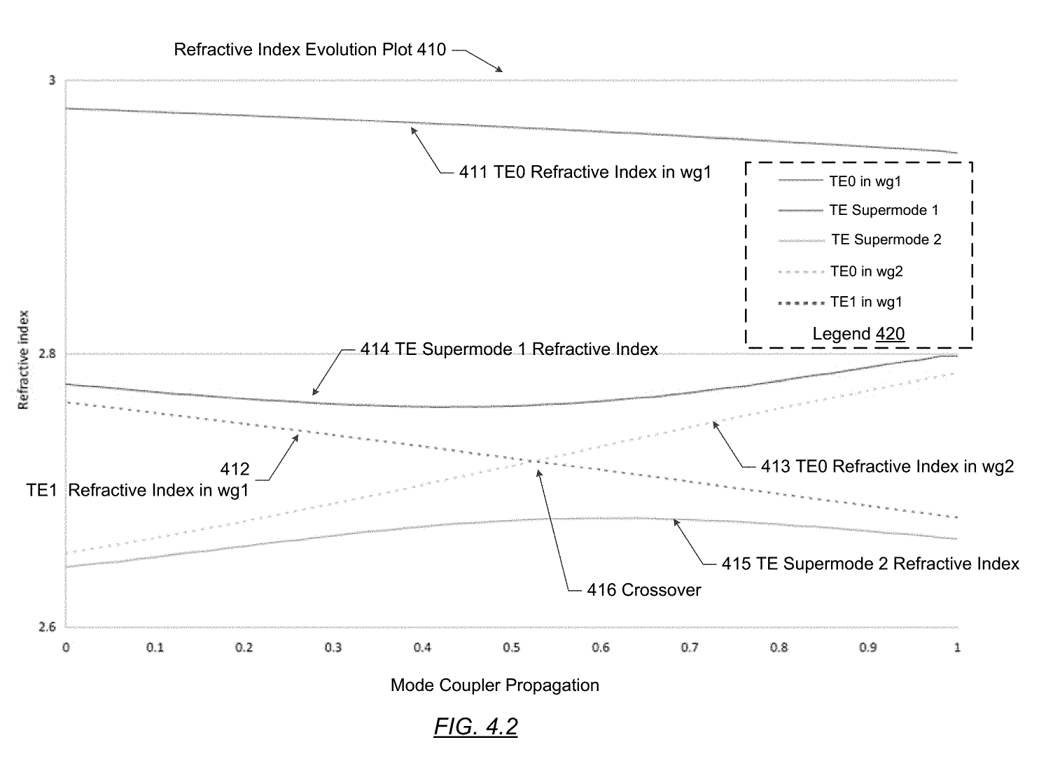

In one or more embodiments of the invention, the EM field patterns in the rib waveguide A (202-2) includes at least a first transverse electric (TE) mode and a second TE mode. Each mode has a refractive index that depends on the cross section geometry of the rib waveguide A (202-2). Generally, the refractive indices of waveguide modes differ from the refractive index in the bulk material forming the waveguide. Throughout this disclosure, the term “refractive index” refers to the refractive index of the waveguide mode instead of the bulk material refractive index. For example, the first TE mode and second TE mode are associated with a first TE mode refractive index and a second TE mode refractive index, respectively, in the rib waveguide A (202-2). Specifically, the first TE mode refractive index and second TE mode refractive index correspond to the EM field patterns in the rib waveguide A (202-2) without taking into account any coupling with another waveguide in proximity. In contrast, super modes exist in a combined geometry of the rib waveguide A (202-2) and rib waveguide B (202-3) and are associated with hybrid refractive indices. An example of super modes and hybrid refractive indices is described in reference to FIG. 4.2 below.

In one or more embodiments, the rib waveguide A (202-2) is configured to propagate an input optical signal from the optical input A (200-2) in the first TE mode and/or the second TE mode. For example, the optical input A (200-2) may include a single TE mode, such as the first TE mode where any second TE mode may be filtered out or otherwise not present. In another example, the optical input A (200-2) may have a portion (referred to as the first TE mode portion) propagating in the first TE mode and/or another portion (referred to as the second TE mode portion) propagating in the second TE mode. In one scenario, the first TE mode portion and the second TE mode portion of the optical input A (200-2) may propagate concurrently through the rib waveguide A (202-2). In another scenario, the first TE mode portion and the second TE mode portion of the optical input A (200-2) may propagate sequentially through the rib waveguide A (202-2). In one or more embodiments, the first TE mode is a fundamental TE mode (referred to as TE0) and the second TE mode is a first order TE mode (referred to as TE1).

Similarly, the EM field patterns in the rib waveguide B (202-3) also includes at least the first TE mode. In particular, the first TE mode has a first TE mode refractive index in the rib waveguide B (202-3) that substantially matches the second TE mode refractive index in the rib waveguide A (202-2). As used here in, “substantially match” means matching at one or more positions across the coupling region (202-8). For example, across the coupling region (202-8), the range of the second TE mode refractive index in the rib waveguide A (202-2) and the range of the first TE mode refractive index in the rib waveguide B (202-3) overlap such that they match each other at one or more crossover points in the coupling region (202-8). An example of overlapping ranges and the crossover of the refractive indices is described in reference to FIG. 4.2 below.

In one or more embodiments of the invention, the coupling region (202-8) is configured to convert the second TE mode portion of the input optical signal into a second optical signal in the rib waveguide B (202-3), referred to as the modal conversion. In particular, the second optical signal is in the first TE mode of the rib waveguide B (202-3). In one or more embodiments, the coupling region (202-8) includes an input side (211) configured to receive the optical input A (200-2) (e.g., having a first TE mode portion in TE0 mode and a second TE mode portion in TE1 mode) into the coupling region (202-8) as the input optical signal. In addition, the coupling region (202-8) includes an output side (212) configured to use the rib waveguide B (202-3) to output the second optical signal (e.g., in the first TE mode, such as TE0 mode). While the second TE mode portion of the optical input A (200-2) is converted into the second optical signal and outputted as the optical output B (200-4), the first TE mode portion of the optical input A (200-2), if any, passes through the coupling region (202-8) as the optical output A (200-3) (e.g., in TE0 mode). The propagation of the input optical signal through the rib waveguide A (202-2) and the propagation of the second optical signal through the rib waveguide B (202-3) are represented by one-sided arrows in FIG. 1.

In one or more embodiments of the invention, the coupling region (202-8) is configured to perform the modal conversion according to a refractive index dependency on the widths of the rib waveguide A (202-2) and rib waveguide B (202-3). Generally, the refractive index is dependent on the wavelength of the EM wave or optical signal. In the mode coupler (202), the refractive index is further dependent on the thickness and widths of the raised portion and partially etched portion of the rib waveguides. As used herein, the thickness or width refers to a dimension in an orthogonal direction with respect to the direction of propagation (i.e., the one-sided arrow) in the rib waveguide A (202-2). In one or more embodiments, the gap (202-4) and widths of the rib waveguide A (202-2) and rib waveguide B (202-3) are selected to substantially match the second TE mode refractive index in the rib waveguide A (202-2) and the first TE mode refractive index in the rib waveguide B (202-3).

In one or more embodiments, the second TE mode refractive index in the rib waveguide A (202-2) differs from the first TE mode refractive index in the rib waveguide B (202-3) at the input side and the output side of the coupling region (202-8). In addition, the widths of the rib waveguide A (202-2) and rib waveguide B (202-3) are variable across the coupling region (202-8) resulting in a cross-over between the second TE mode refractive index in the rib waveguide A (202-2) and the first TE mode refractive index in the rib waveguide B (202-3). In such embodiments, the modal conversion occurring via the gap (202-4) is referred to as mode evolution. An example of the mode evolution is described in reference to FIGS. 4.1 and 4.2 below. In one or more embodiments, the widths of the rib waveguide A (202-2) and rib waveguide B (202-3) are constant across the coupling region (202-8) and are selected such that the refractive indices of the first and second TE modes coinciding each other across the coupling region (202-8). In such embodiments, the modal conversion occurring via the gap (202-4) is referred to as mode beating.

The effectiveness of the modal conversion is represented by a modal conversion efficiency, which may be computed as the ratio between the energy in the second TE mode portion in the rib waveguide A (202-2) at optical output A (200-3) versus the energy in the second optical signal in the first TE mode of the rib waveguide B (202-3) at optical output B (200-4). In one or more embodiments, the gap (202-4) and widths of the rib waveguide A (202-2) and rib waveguide B (202-3) are selected such that the modal conversion efficiency exceeds a pre-determined level, such as 99% within the coupling region (202-8). In one or more embodiments, the modal conversion efficiency is proportional to a length (along the direction of signal propagation) of the coupling region (202-8). For example, the pre-determined may be chosen based on the length of the coupling region (202-8). In one or more embodiments, the gap (202-4) and widths of the rib waveguide A (202-2) and rib waveguide B (202-3) are selected to satisfy a minimum-spacing (e.g., 150 nm) and minimum-width (e.g., 200 nm) criterion of fabricating the rib waveguide A (202-2) and rib waveguide B (202-3). An example of selecting the gap (202-4) and widths of the rib waveguide A (202-2) and rib waveguide B (202-3) is described in reference to FIG. 4.1 below.

As further shown in FIG. 1, the width of the rib waveguide A (202-2) is represented by double-sided arrows labeled Wa and Wb at the input side (211) and output side (212), respectively. Similarly, the width of the rib waveguide B (202-3) is represented by double-sided arrows labeled We and Wd at the input side (211) and output side (212), respectively.

In one or more embodiments, the widths of the rib waveguide A (202-2) and rib waveguide B (202-3) vary across the coupling region (202-8). For example, the rib waveguide A (202-2) and rib waveguide B (202-3) may be in a trapezoid shape where Wa>Wb and Wc<Wd. In such embodiments, the mode coupler (202) is an adiabatic coupler that operates using mode evolution principle. The term “adiabatic” refers to a lossless aspect of the mode coupler. Although the widths of the rib waveguide A (202-2) and rib waveguide B (202-3) are shown as varying monotonically across the coupling region (202-8), in some embodiments, at least one of the widths of the rib waveguide A (202-2) and rib waveguide B (202-3) vary non-monotonically across the coupling region (202-8).

Although not shown in FIG. 1, in some embodiments, the widths of the rib waveguide A (202-2) and rib waveguide B (202-3) are constant across the coupling region (202-8). For example, the rib waveguide A (202-2) and rib waveguide B (202-3) may be in a rectangular shape where Wa=Wb and Wc=Wd. In such embodiments, the mode coupler (202) is a directional coupler that operates using a mode beating principle. With the mode beating approach, the rib waveguide widths are selected so that the second TE mode refractive index in the rib waveguide A and the first TE mode refractive index in the rib waveguide B coincide across the coupling region (202-8). Further, the lengths of the rib waveguide A (202-2) and rib waveguide B (202-3) are selected to match half a beating length of the directional coupler in order to achieve efficient modal conversion from the optical input A (200-2) to optical output B (200-4). With the mode evolution approach, the rib waveguide widths have to be selected so that the second TE mode refractive index in the rib waveguide A and the first TE mode refractive index in the rib waveguide B coincide at one point (i.e., cross-over) along the coupling region (202-8) length. Further, the length of the coupling region (202-8) is selected such that the modal evolution is sufficiently long for adiabatic modal conversion with no substantial radiative loss. The mode evolution approach is more tolerant than the mode beating approach under fabrication variations. For example, a fabrication variation of +/−50 nm on rib waveguide widths Wa, Wb, We and Wd is possible without substantial degradation in the modal conversion efficiency based on mode evolution.

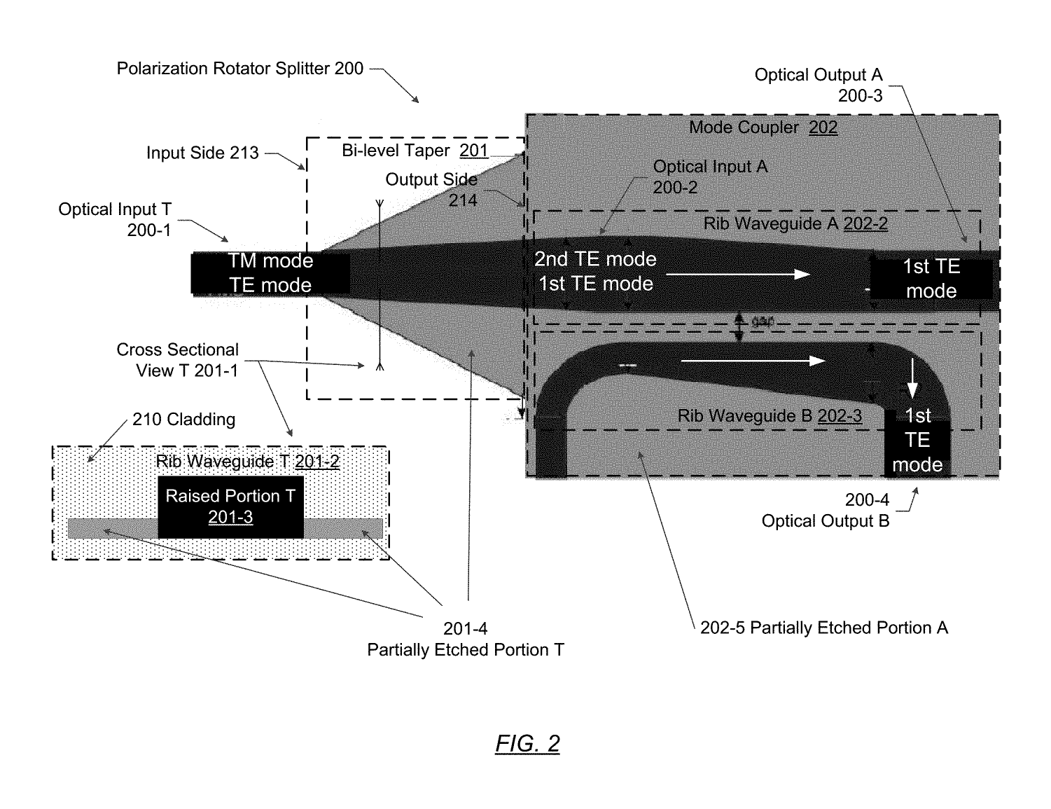

FIG. 2 shows a schematic diagram of a polarization rotator splitter (200) in accordance with one or more embodiments of the invention. In one or more embodiments of the invention, one or more of the elements shown in FIG. 2 may be omitted, repeated, and/or substituted. Accordingly, embodiments of the invention should not be considered limited to the specific arrangements of modules shown in FIG. 2.

As shown in FIG. 2, the polarization rotator splitter (200) includes the bi-level taper (201) and the mode coupler (202). Specifically, details of the mode coupler (202) are described in reference to FIG. 1 above. In one or more embodiments of the invention, the bi-level taper (201) is implemented as a rib waveguide T (201-2) with a tapered form factor, shown in a cross-sectional view T (201-1). Specifically, the bi-level taper (201) or rib waveguide T (201-2) are fabricated using the same silicon photonics fabrication process as the mode coupler (202) and collectively enclosed in the cladding (210). For example, the thickness of the raised portion T (201-3) is between 300 nm and 400 nm and the thickness of the partially etched portion T (201-4) is between 100 nm and 250 nm. In addition, the width of the raised portion T (201-3) is substantially the same as the width of the rib waveguide A (202-2). In one or more embodiments, the width of the partially etched portion T (201-4) increases monotonically from the input side (213) to the output side (214) to form a tapered form factor. In one or more embodiments, during the silicon photonics fabrication process, the rib waveguide A (202-2), rib waveguide B (202-3), and rib waveguide T (201-2) are fabricated from the same single silicon layer. For example, the raised portion T (201-3) and the raised portions of the rib waveguide A (202-2) and rib waveguide B (202-3) have the same thickness. In one or more embodiments, the partially etched portion T (201-4) and the partially etched portion A (202-5) are selectively etched in the same processing step from the single silicon layer to reduce the thickness for forming the rib configuration. In addition, an extra etch processing step is performed to define the taper geometry of the partially etched portion T (201-4).

As further shown in FIG. 2, the optical input T (200-1) is an input optical signal of the bi-level taper (201). As noted above, the optical input A (200-2) is the input optical signal of the mode coupler (202) that is received from the output of the bi-level taper (201). The optical output A (200-3) and optical output B (200-4) are generated by the mode coupler (202) as the optical output signals of the polarization rotator splitter (200). In particular, the optical input T (200-1) includes a TE mode (e.g., TE0) portion and a TM mode (e.g., TMO) portion. The TE mode (e.g., TE0) portion of the optical input T (200-1) passes through the bi-level taper (201) and becomes the first TE mode portion (e.g., in TE0 mode) of the optical input A (200-2). In contrast, the TM mode (e.g., TMO) portion of the optical input T (200-1) is converted by the bi-level taper (201) into the second TE mode portion (e.g., in TE1 mode) of the optical input A (200-2). Further, the first TE mode portion (e.g., in TE0 mode) of the optical input A (200-2) passes through the rib waveguide A (202-2) as the optical out A (200-3). In contrast, the second TE mode portion (e.g., in TE1 mode) of the optical input A (200-2) is converted into a first TE mode (e.g., in TE0 mode) optical signal propagating in the rib waveguide B (202-3) as the optical output B (200-4).

Although FIGS. 1 and 2 show a particular configuration of components, other configurations may be used without departing from the scope of the invention. For example, some components shown may not exist in some embodiments. Other components not shown may exist.

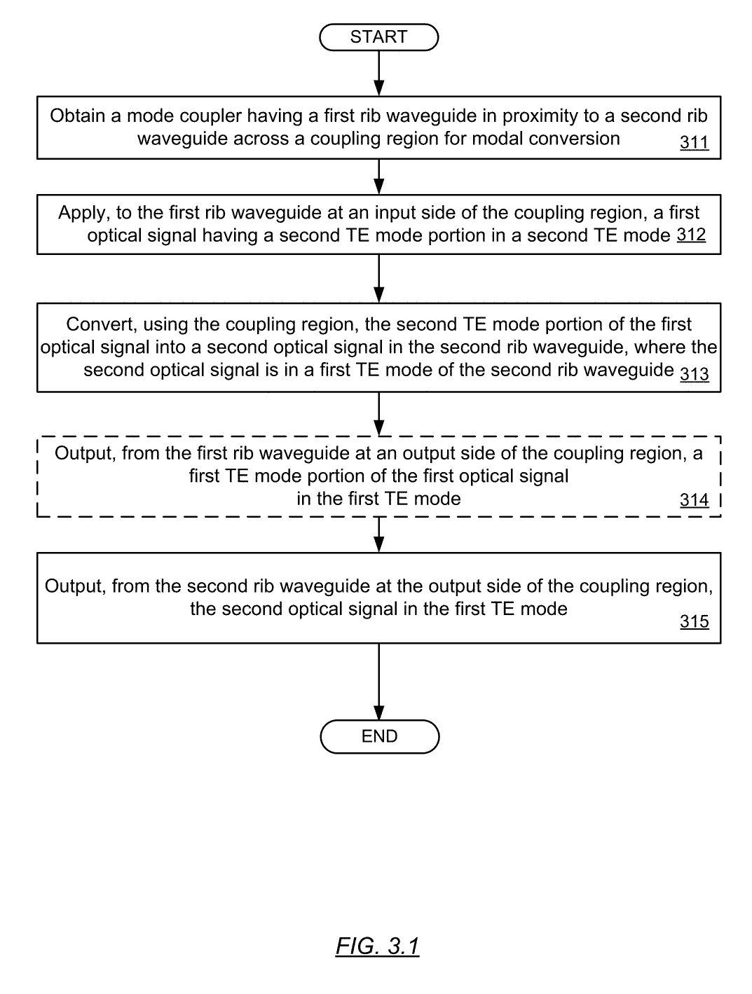

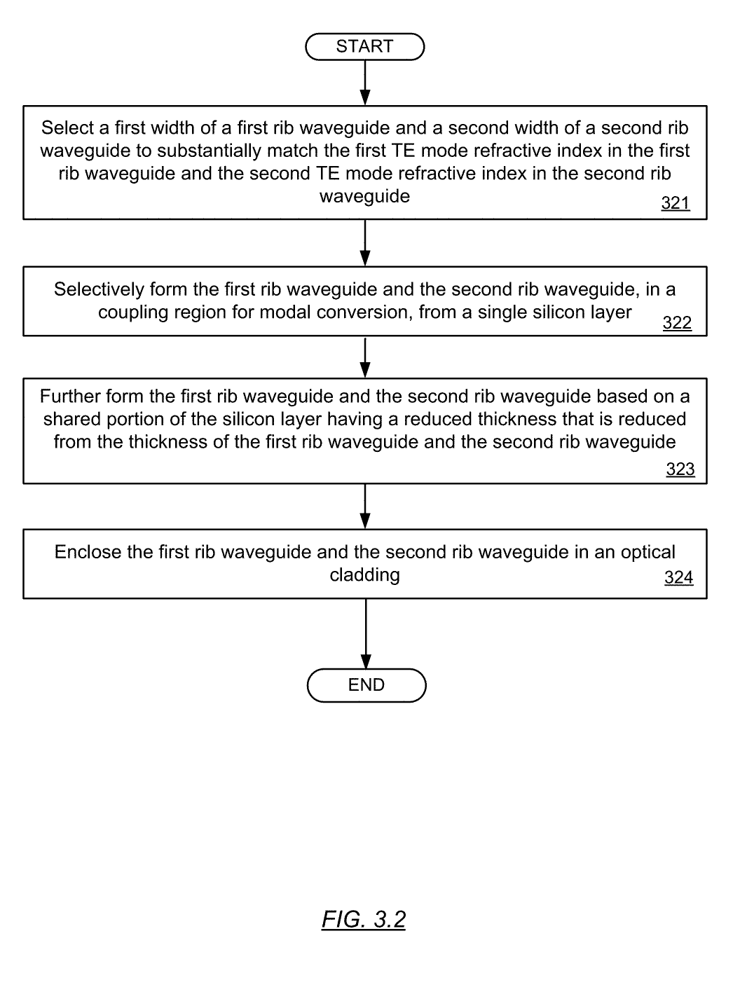

FIG. 3.1 shows a flowchart in accordance with one or more embodiments. One or more steps shown in FIG. 3.1 may be omitted, repeated, and/or performed in a different order among different embodiments of the invention. Accordingly, embodiments of the invention should not be considered limited to the specific number and arrangement of steps shown in FIG. 3.1.

Initially, in Step 311, a mode coupler is obtained that has a first rib waveguide in proximity to a second rib waveguide across a coupling region for modal conversion. In one or more embodiments of the invention, the first rib waveguide has a second transverse electric (TE) mode refractive index of a second TE mode that substantially matches a first TE mode refractive index of a first TE mode in the second rib waveguide.

In Step 312, a first optical signal is applied to the first rib waveguide at an input side of the coupling region. In one or more embodiments, the first optical signal includes at least a portion (referred to as the second TE mode portion) propagating in the second TE mode. In one or more embodiments, the first optical signal is applied from an output of a bi-level taper disposed at the input side of the coupling region.

In Step 313, using the coupling region, the second TE mode portion of the first optical signal is converted into a second optical signal in the second rib waveguide. In particular, the second optical signal is in the first TE mode of the second rib waveguide. Further, using the bi-level taper, a portion of an input optical signal propagating in a transverse magnetic (TM) mode (referred to as the TM mode portion of the input optical signal) is converted into the second TE mode portion of the first optical signal in the second TE mode.

In Step 314, a first TE mode portion, if any, in the first TE mode of the first optical signal is outputted from the first rib waveguide at an output side of the coupling region. In one or more embodiments, the first TE mode of the first optical signal passes through the mode coupler while staying in the rib waveguide A (202-2).

In Step 315, the second optical signal in the first TE mode is outputted from the second rib waveguide at the output side of the coupling region.

FIG. 3.2 shows a flowchart in accordance with one or more embodiments.

The process depicted in FIG. 3.2 may be used to design and/or manufacture the mode coupler and/or polarization rotator splitter described in reference to FIGS. 1 and 2 above. One or more steps shown in FIG. 3.2 may be omitted, repeated, and/or performed in a different order among different embodiments of the invention. Accordingly, embodiments of the invention should not be considered limited to the specific number and arrangement of steps shown in FIG. 3.2.

Initially in Step 321, a first width of a first rib waveguide and a second width of a second rib waveguide are selected to substantially match the second TE mode refractive index in the first rib waveguide and the first TE mode refractive index in the second rib waveguide. In particular, the first width, the second width, and the spacing are selected based on an operating wavelength of the mode coupler and a thickness of the first rib waveguide and the second rib waveguide. In one or more embodiments, the thickness of the first rib waveguide and the second rib waveguide is based on a single silicon layer thickness used in a silicon photonics fabrication process. Further, the spacing is based at least on a minimum-spacing criterion of the silicon photonics fabrication process.

In Step 322, the first rib waveguide and the second rib waveguide are selectively formed in a coupling region for modal conversion. In one or more embodiments, the first rib waveguide and the second rib waveguide are selectively formed from a single silicon layer and enclosed in an optical cladding.

In Step 323, the first rib waveguide and the second rib waveguide are further formed based on a shared portion of the silicon layer having a reduced thickness that is reduced from the thickness of the first rib waveguide and the second rib waveguide.

In Step 324, the first rib waveguide and the second rib waveguide are enclosed in an optical cladding.

FIGS. 4.1 and 4.2 show an example in accordance with one or more embodiments of the invention. The example shown in FIGS. 4.1 and 4.2 may be based on the mode coupler, the polarization rotator splitter, and the method flow chart discussed in reference to FIGS. 1, 2, 3.1, and 3.2 above. In one or more embodiments, one or more of the modules and elements shown in FIGS. 4.1 and 4.2 may be omitted, repeated, and/or substituted. Accordingly, embodiments of the invention should not be considered limited to the specific arrangements of modules shown in FIGS. 4.1 and 4.2.

Specifically, FIG. 4.1 shows a refractive index plot (400) showing the dependency of the refractive indices with respect to the width of two independent rib waveguides. In particular, the waveguide width is shown along the X-axis while the refractive index is shown along the Y-axis without specifying exact values. In one or more embodiments of the invention, the refractive index plot (400) includes computed results based on waveguide geometry of a particular silicon photonics fabrication process and the material refractive index. Accordingly, the refractive index plot (400) is specific to the thickness of the rib waveguides. In particular, the refractive index plot (400) is for an example having a raised portion thickness of approximately 300 nm and a partially etched portion thickness of approximately 150 nm, and an operating wavelength in the optical spectrum, such as 1.55 micro-meters.

As shown in FIG. 4.1, the refractive index plot (400) includes a TE1 refractive index curve (401) and a TE0 refractive index curve (402).

Accordingly, a width of the first rib waveguide “wg1” (e.g., rib waveguide A (202-2) depicted in FIG. 1) is selected as the width A (403). To match the TE1 mode refractive index in the first rib waveguide to the TE0 mode refractive index in the second rib waveguide “wg2” (e.g., rib waveguide B (202-3) depicted in FIG. 1), a width of the second rib waveguide is selected as the width B (404). For example, as noted above, the rib waveguide A (202-2) and rib waveguide B (202-3) may have constant widths A and B, respectively, across the coupling region (202-8) to operate as a directional coupler using the mode beating mechanism. In another example, the rib waveguide A (202-2) and rib waveguide B (202-3) may have widths A and B respectively, in at least one cross sectional view (e.g., cross sectional view A (202-1) depicted in FIG. 1) within the coupling region (202-8) to operate as a mode coupler using the mode evolution mechanism. An example of the mode evolution is described in reference to FIG. 4.2 below.

FIG. 4.2 shows a refractive index evolution plot (410) showing various refractive indices with respect to the mode coupler propagation from the input side to the output side of the coupling region (202-8) depicted in FIG. 1. In particular, the mode coupler propagation is shown along the X-axis to represent a waveform position of a propagating optical signal. The waveform position is normalized where 0 denotes the input side and 1 denotes the output side. In addition, refractive index values are shown along the Y-axis. The refractive index evolution plot (410) is based on the 900 nm width of the rib waveguide A (202-2) and the 320 nm width of the rib waveguide B (202-3) in the cross sectional view A (202-1) depicted in FIG. 1 above. Specifically, the 900 nm and 320 nm widths are selected according to the refractive index plot (400) depicted in FIG. 4.1 above.

As shown in FIG. 4.2, the refractive index evolution plot (410) shows various refractive indices according to the legend (420), such as the TE0 refractive index in wg1 (411), TE1 refractive index in wg1 (412), TE0 refractive index in wg2 (413), TE supermode 1 refractive index (414), and TE supermode 2 refractive index (415). For example, the TE0 refractive index in wg1 (411) and TE1 refractive index in wg1 (412) represent the TE0 refractive index and TE1 refractive index, respectively, of the rib waveguide A (202-2) depicted in FIG. 1 above. In particular, the TE1 refractive index in wg1 (412) is based on the TE1 refractive index curve (401) depicted in FIG. 4.1 above. The TE0 refractive index in wg1 (411) and TE1 refractive index in wg1 (412) monotonically decrease, as the mode coupler propagation increases from 0 to 1, due to the monotonically decreasing width of the rib waveguide A (202-2) from Wa to Wb.

Similarly, the TE0 refractive index in wg2 (413) represents the TE0 refractive index of the rib waveguide B (202-3) depicted in FIG. 1 above. In particular, the TE0 refractive index in wg2 (413) is based on the TE0 refractive index curve (402) depicted in FIG. 4.1 above. Accordingly, the crossover (416) corresponds to matching the TE1 refractive index of the rib waveguide A (202-2) and TE0 refractive index of the rib waveguide B (202-3) described in reference to FIG. 4.1 above. The TE0 refractive index in wg2 (413) monotonically increases, as the mode coupler propagation increases from 0 to 1, due to the monotonically increasing width of the rib waveguide B (202-3) from We to Wd.

The TE1 refractive index in wg1 (412) and TE0 refractive index in wg2 (413) correspond to electromagnetic field patterns in a single waveguide (i.e., rib waveguide A (202-2), rib waveguide B (202-3)) without taking into account any coupling with another waveguide in proximity. In contrast, the TE1 in rib waveguide A (202-2) crossing over to TE0 in rib waveguide B (202-3) is associated with supermode 1 in the combined geometry of the rib waveguide A (202-2) and rib waveguide B (202-3). In particular, the super modes correspond to electromagnetic field patterns in the combined geometry taking into account the mode evolution mechanism. Similarly, the TE0 in rib waveguide B (202-3) crossing over to TE1 in rib waveguide A (202-2) is associated with super mode 2 in the combined geometry. The TE supermode 1 refractive index (414) is approximately equivalent to the TE1 refractive index in wg1 (412) where the mode coupler propagation equals 0. This approximate equivalence indicates that the EM field pattern of the supermode 1 is substantially similar to the TE1 mode in the rib waveguide A (202-2). In contrast, the TE supermode 1 refractive index (414) is approximately equivalent to the TE0 refractive index in wg2 (413) where the mode coupler propagation equals 1. This approximate equivalence indicates that the EM field pattern of the supermode 1 is substantially similar to the TE0 mode in the rib waveguide B (202-3). Specifically, the mode evolution refers to the transition of the supermode EM field pattern from being similar to the TE1 mode in the rib waveguide A (202-2) to being similar to the TE0 mode in the rib waveguide B (202-3). In other words, the mode evolution is the conversion of the TE1 mode energy in the rib waveguide A (202-2) into the TE0 mode energy in the rib waveguide B (202-3) as the optical signal waveform propagates from the input side (211) to the output side (212) shown in FIG. 1 above. The mode evolution is effective when the TE1 refractive index in wg1 (412) and TE0 refractive index in wg2 (413) are sufficiently different from each other at the input side (211) and the output side (212). As the gap (202-4) increases in width, the complete mode evolution (i.e., modal conversion efficiency of 99% or higher) occurs in a longer distance of the coupling region (202-8). In contrast, the mode evolution may complete in a shorter distance of the coupling region (202-8) as the gap (202-4) decreases in width.

Although the example shown in FIG. 4.2 describes the optical signal propagating from the input side (211) to the output side (212), the mode coupler (202) may be used in a reverse direction. For example, a TE0 mode optical signals may propagate in the rib waveguide B (202-3) from the output side (212) and convert into a TE1 mode optical signal propagating in the rib waveguide A (202-2) that exits the input side (211). Similarly, two TE0 mode optical signals may propagate separately in the rib waveguide A (202-2) and rib waveguide B (202-3) from the output side (212) and combine into a single optical signal propagating in both TE0 and TE1 mode to exit the input side (211). In this reverse direction usage of the mode coupler (202), the mode evolution is based on the TE supermode 1 refractive index (414). In a similar fashion, the polarization rotator splitter (200) depicted in FIG. 2 above may also be used in a reverse direction. For example, two TE0 mode optical signals propagating separately in the rib waveguide A (202-2) and rib waveguide B (202-3) from the outputs of the polarization rotator splitter (200) may be combined into a single optical signal propagating in the TMO and TE0 modes to exit the input of the polarization rotator splitter (200).

Although the example shown in FIG. 4.2, in particular the crossover (416), is based on the monotonically decreasing width of the rib waveguide A (202-2) and the monotonically increasing width of the rib waveguide B (202-3), the width variations of the two rib waveguides may be non-monotonic across the coupling region (202-8) without deviating from the mode evolution principal employed in the mode coupler (202). In other words, non-monotonic width variations of the rib waveguides may be used in the mode coupler (202) so long as a crossover between the TE1 refractive index in wg1 (412) and TE0 refractive index in wg2 (413) occurs in at least one point across the coupling region (202-8).

Although the example shown in FIGS. 4.1 and 4.2 is based on the operating wavelength of the mode coupler in the optical spectrum, the mode coupler may use other operating wavelength ranges (e.g., corresponding to near-infrared or radio frequencies) by altering the waveguide geometry, changing the waveguide material and/or other fabrication parameters. In particular, the waveguide material is to be transparent at the operating wavelength and have a significantly higher refractive index than the cladding in order to generate hybrid TE/TM modes.

The invention may be adapted to CMOS foundries that use silicon waveguide thickness greater than 220 nm and minimum feature size greater than 100 nm. With silicon waveguide thickness greater than 220 nm, the strip waveguide modes are highly localized within the core with no efficient coupling in adjacent strip waveguides. In particular, implementing a mode coupler using strip waveguides having thickness greater than 220 nm results in a narrower gap than 100 nm. This narrow gap violates the minimum feature size requirement of various CMOS foundries. By using the rib waveguides, the invention allows the mode coupler to be implemented using silicon waveguide thickness greater than 220 nm while meeting the greater than 100 nm minimum feature size requirement of the aforementioned CMOS foundries. Further, polarization rotator splitter advantageously implemented using rib waveguides has more compact form factor than the implementation using strip waveguides.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1.-20. (canceled)

21. A mode coupler for generating a first transverse electric (TE) mode from a second TE mode of signal propagation, comprising:
a first rib waveguide having at least the second TE mode of signal propagation, wherein the first rib waveguide is configured to propagate at least through a coupling region for modal conversion, a first optical signal comprising a second TE mode signal portion in the second TE mode, wherein the second TE mode is associated with a second TE mode refractive index in the first rib waveguide;
a second rib waveguide having at least the first TE mode of signal propagation, wherein the second rib waveguide is disposed in proximity to the first rib waveguide across the coupling region, wherein the first TE mode is associated with a first TE mode refractive index in the second rib waveguide that corresponds to the second TE mode refractive index in the first rib waveguide; and
the coupling region configured to convert the second TE mode signal portion of the first optical signal into a second optical signal in the second rib waveguide, wherein the second optical signal is in the first TE mode of the second rib waveguide, wherein the modal conversion is based on mode beating,
wherein the first rib waveguide comprises a first width that is constant in at least a portion of the coupling region, and
wherein the second rib waveguide comprises a second width that is constant in at least the portion of the coupling region.

22. The mode coupler of claim 21, wherein the coupling region comprises:
an input side configured to receive the first optical signal into the coupling region, wherein the first optical signal further comprises a first TE mode signal portion in the first TE mode;
an output side configured to
output, using the first rib waveguide, the first TE mode signal portion of the first optical signal in the first TE mode, and
output, using the second rib waveguide, the second optical signal in the first TE mode; and
an optical cladding configured to retain the first rib waveguide to be in proximity to the second rib waveguide.

23. The mode coupler of claim 22,
wherein the first width and the second width are selected to match the second TE mode refractive index in the first rib waveguide and the first TE mode refractive index in the second rib waveguide, and
wherein the first width and the second width are selected based on a wavelength of the first optical signal, a thickness of the first rib waveguide and a thickness of the second rib waveguide.

24. The mode coupler of claim 23,
wherein the first rib waveguide and the second rib waveguide are selectively formed from a silicon layer and enclosed in the optical cladding, and
wherein the first rib waveguide and the second rib waveguide are formed based on a shared portion of the silicon layer having a reduced thickness that is reduced from the thickness of the first rib waveguide and the second rib waveguide.

25. The mode coupler of claim 24,
wherein the coupling region comprises a constant spacing between the first rib waveguide and the second rib waveguide, wherein the constant spacing is selected such that a modal conversion efficiency exceeds a pre-determined level,
wherein the constant spacing satisfies a minimum-spacing criterion of fabricating the first rib waveguide and the second rib waveguide.

26. The mode coupler of claim 25,
wherein the thickness is between 300 nm and 400 nm,
wherein the reduced thickness is between 100 nm and 250 nm, and
wherein the spacing is between 200 nm and 400 nm.

27. A polarization rotator splitter for splitting an input optical signal into separate outputs in a first transverse electric (TE) mode of signal propagation, comprising:
a bi-level taper disposed at an input side of a coupling region and configured to
convert a transverse magnetic (TM) mode signal portion of the input optical signal into a second TE mode signal portion, in a second TE mode, of a first optical signal; and
a mode coupler coupled to the bi-level taper, comprising
a first rib waveguide having the first TE mode and the second TE mode of signal propagation, wherein the first rib waveguide is configured to propagate the first optical signal at least through the coupling region for modal conversion, wherein the second TE mode is associated with a second TE mode refractive index in the first rib waveguide;
a second rib waveguide having at least the first TE mode of signal propagation, wherein the second rib waveguide is disposed in proximity to the first rib waveguide across the coupling region, wherein the first TE mode is associated with a first TE mode refractive index in the second rib waveguide that corresponds to the second TE mode refractive index in the first rib waveguide; and
the coupling region configured to convert the second TE mode signal portion of the first optical signal into a second optical signal in the second rib waveguide, wherein the second optical signal is in the first TE mode of the second rib waveguide, wherein the modal conversion is based on mode beating,
wherein the first rib waveguide comprises a first width that is constant in at least a portion of the coupling region, and
wherein the second rib waveguide comprises a second width that is constant in at least the portion of the coupling region.

28. The polarization rotator splitter of claim 27, wherein the coupling region comprises:
an input side configured to receive the first optical signal into the coupling region, wherein the first optical signal further comprises a first TE mode signal portion in the first TE mode;
an output side configured to
output, using the first rib waveguide, the first TE mode signal portion of the first optical signal in the first TE mode, and
output, using the second rib waveguide, the second optical signal in the first TE mode; and
an optical cladding configured to retain the first rib waveguide to be in proximity to the second rib waveguide;
wherein the TM mode comprises a fundamental TM mode, the first TE mode comprises a fundamental TE mode, and the second TE mode comprises a first order TE mode.

29. The polarization rotator splitter of claim 28,
wherein the first width and the second width are selected to match the second TE mode refractive index in the first rib waveguide and the first TE mode refractive index in the second rib waveguide, and
wherein the first width and the second width are selected based on a wavelength of the first optical signal, a thickness of the first rib waveguide and a thickness of the second rib waveguide.

30. The polarization rotator splitter of claim 29,
wherein the first rib waveguide and the second rib waveguide are selectively formed from a silicon layer and enclosed in the optical cladding, and
wherein the first rib waveguide and the second rib waveguide are formed based on a shared portion of the silicon layer having a reduced thickness that is reduced from the thickness of the first rib waveguide and the second rib waveguide.

31. The polarization rotator splitter of claim 30,
wherein the coupling region comprises a constant spacing between the first rib waveguide and the second rib waveguide, wherein the constant spacing is selected such that a modal conversion efficiency exceeds a pre-determined level,
wherein the substantially constant spacing satisfies a minimum-spacing criterion of fabricating the first rib waveguide and the second rib waveguide.

32. The polarization rotator splitter of claim 31,
wherein the thickness is between 300 nm and 400 nm,
wherein the reduced thickness is between 100 nm and 250 nm, and
wherein the spacing is between 200 nm and 400 nm.

33. A method for modal conversion to generate a first transverse electric (TE) mode from a second TE mode of signal propagation, comprising:
providing a mode coupler comprising a first rib waveguide in proximity to a second rib waveguide across a coupling region for the modal conversion, wherein the first rib waveguide comprises a second TE mode refractive index of a second TE mode that matches a first TE mode refractive index of the first TE mode in the second rib waveguide;
applying, to the first rib waveguide at an input side of the coupling region, a first optical signal comprising a second TE mode signal portion in the second TE mode; and
converting, using the coupling region, the second TE mode signal portion of the first optical signal into a second optical signal in the second rib waveguide, wherein the second optical signal is in the first TE mode of the second rib waveguide, wherein the modal conversion is based on mode beating,
wherein the first rib waveguide comprises a first width that is constant in at least a portion of the coupling region, and
wherein the second rib waveguide comprises a second width that is constant in at least the portion of the coupling region.

34. The method of claim 33, further comprising:
outputting, from the first rib waveguide at an output side of the coupling region, a first TE mode signal portion of the first optical signal in the first TE mode; and
outputting, from the second rib waveguide at the output side of the coupling region, the second optical signal in the first TE mode.

35. The method of claim 33, further comprising:
wherein the first width and the second width are selected to match the second TE mode refractive index in the first rib waveguide and the first TE mode refractive index in the second rib waveguide, and
wherein the first width and the second width are selected based on a wavelength of the first optical signal, a thickness of the first rib waveguide and a thickness the second rib waveguide.

36. The method of claim 35,
wherein the first rib waveguide and the second rib waveguide are selectively formed from a silicon layer and enclosed in an optical cladding, and
wherein the first rib waveguide and the second rib waveguide are formed based on a shared portion of the silicon layer having a reduced thickness that is reduced from the thickness of the first rib waveguide and the second rib waveguide.

37. The method of claim 35, further comprising:
selecting, for the coupling region, a constant spacing between the first rib waveguide and the second rib waveguide such that a modal conversion efficiency exceeds a pre-determined level,
wherein the spacing satisfies a minimum-spacing criterion of fabricating the first rib waveguide and the second rib waveguide.

38. The method of claim 33, further comprising:
disposing, at the input side of the coupling region, a bi-level taper; and
converting, using the bi-level taper, a transverse magnetic (TM) mode signal portion of an input optical signal into the second TE mode signal portion of the first optical signal in the second TE mode,
wherein the TM mode comprises a fundamental TM mode, the first TE mode comprises a fundamental TE mode, and the second TE mode comprises a first order TE mode.
